(19) United States
(12) Patent Application Publication
(10) Pub. No.: US 2026/0299523 A1
(43) Pub. Date: Oct. 1, 2026

(54) Proactive Thermal Control for a System-on-Chip

(71) Applicant: Google LLC, Mountain View, CA (US)

(72) Inventors: Mohsen Heidarinejad, San Jose, CA (US); Arpit Mittal, San Jose, CA (US)

(73) Assignee: Google LLC, Mountain View, CA (US)

(21) Appl. No.: 19/095,286

(22) Filed: Mar. 31, 2025

(51) Int. Cl. G05B 13/02

(52) U.S. Cl. CPC G05B 13/026

(57) ABSTRACT

Techniques and apparatuses are described for implementing proactive thermal control for a system-on-chip. In example aspects, a thermal-control system utilizes a prediction model to predict a future evolution of an SoC based on a current operation point and a current temperature of the SoC. The prediction is used to proactively update a thermal-control policy that manipulates an operation point of one or more subsystems of the SoC. In aspects, a user perception of a thermal limit to an enclosure (e.g., surface temperature of a surface of the enclosure that the user touches) of a device having the SoC is also used to determine tradeoffs and contradicting goals between the calculated power/thermal metrics for the device and the user's perception of the thermal limit for the enclosure (e.g., surface temperature that the user touches).

### BACKGROUND

An electronic device can be implemented with a system-on-chip (SoC), which can provide many features of the electronic device. An example SoC can include multiple subsystems, such as a central processing unit (CPU), a graphics processing unit (GPU), an image processing unit (IPU), and/or a tensor processing unit (TPU). As a user engages with the electronic device, operations of these subsystems can generate heat. Left unchecked, the accumulation of heat within the electronic device can result in a high temperature that can damage the SoC, can damage other components of the electronic device, and/or can reduce a reliability of the electronic device. In some cases, the electronic device can become unsafe for the user to operate.

To safeguard against overheating, many existing devices implement a thermal-throttling process in the SoC, which is a reactive process that suffers from inherent limitations that compromise optimal performance and user experience. This reactive throttling has a delayed response, activating only after reaching a critical temperature threshold, which can lead to user-perceivable performance degradation and lag, particularly during resource-intensive tasks. The abrupt on/off nature of these conventional mechanisms may introduce jarring performance fluctuations, creating an inconsistent and frustrating user experience. Furthermore, the simplistic threshold-based approach of the conventional systems may lead to overly aggressive performance reduction, sacrificing processing capacity even when a more nuanced approach could sustain operation at a slightly elevated temperature. In addition, reactive mitigation does not inherently prioritize power optimization and efficiency, potentially leading to increased energy consumption in other system components as they compensate for the performance degradation.

### SUMMARY

Techniques and apparatuses are described for implementing proactive thermal control for an SoC. In example aspects, a thermal-control system utilizes a prediction model to predict a future evolution of an SoC based on a current operation point and a current temperature of the SoC. The prediction, along with live calculated power/thermal metrics and weighted metric thresholds, is used to proactively update a thermal-control policy that manipulates the operation point of one or more subsystems of the SoC. In aspects, a user perception of a thermal limit to an enclosure (e.g., surface temperature of a surface of the enclosure that the user touches) of a device having the SoC is also used to determine tradeoffs and contradicting goals between the calculated power/thermal metrics for the device and the user's perception of the thermal limit for the enclosure.

In aspects, a method performed by a system-on-chip is disclosed. The method includes obtaining, by a thermal-control system of the system-on-chip, a prediction indicating an estimation of a future temperature of a subsystem of the system-on-chip based on a current operation point and a current temperature of the subsystem. The method further includes generating, by a policy adjustor of the thermal-control system and based on the prediction, a thermal-control policy for a controller associated with the subsystem, the thermal-control policy defining a temperature target and a cadence for the controller. In addition, the method includes determining, by the controller, a new operation point for the subsystem based on the thermal-control policy. The method also includes enforcing, by the subsystem, the new operation point for proactive thermal mitigation.

In aspects, a system-on-chip is disclosed. The system-on-chip includes at least one subsystem and at least one thermal-control system coupled to the at least one subsystem. The at least one thermal-control system includes a predictor configured to generate a prediction indicating an estimation of a future temperature of the at least one subsystem based on a current operation point and a current temperature of the at least one subsystem. In addition, the at least one subsystem includes one or more controllers configured to generate proposed operation points for the at least one subsystem. The at least one subsystem also includes a policy adjustor configured to generate, based on the prediction, a thermal-control policy for the one or more controllers associated with the at least one subsystem, the thermal-control policy defining a temperature target and a cadence for the one or more controllers. In addition, the at least one subsystem includes a selector logic configured to select one operation point from the proposed operation points to be enforced by the subsystem for proactive thermal mitigation.

This summary is provided to introduce simplified concepts of a proactive thermal control for an SoC, which are further described below in the Detailed Description. This summary is not intended to identify essential features of the claimed subject matter, nor is it intended for use in determining the scope of the claimed subject matter.

### BRIEF DESCRIPTION OF DRAWINGS

Apparatuses and techniques for implementing proactive thermal control for a system-on-chip (SoC) are described with reference to the following drawings. The same numbers are used throughout the drawings to reference like features and components:

FIG. 1 illustrates an example environment in which proactive thermal control for an SoC can be implemented;

FIG. 2 illustrates an example implementation of a computing device that can implement aspects of proactive thermal control for an SoC;

FIG. 3 illustrates an example relationship between a subsystem and a thermal-control system of an SoC;

FIG. 4 illustrates a graph of example operation points of a subsystem;

FIG. 5 illustrates an example implementation of a thermal-control system for an SoC;

FIG. 6 illustrates an example implementation of the thermal-control system for an SoC;

FIG. 7 illustrates an example method for performing proactive thermal control for an SoC; and

FIG. 8 illustrates an example computing system embodying, or in which techniques may be implemented that enable use of, proactive thermal control for an SoC.

### DETAILED DESCRIPTION

An electronic device can be implemented with a system-on-chip (SoC), which can provide many features of the electronic device. An example SoC can include multiple subsystems, such as a CPU, a GPU, and/or an IPU. As a user engages with the electronic device, operations of these subsystems can generate heat. To avoid overheating and causing potential damage to the SoC and other components of the electronic device, thermal-mitigation techniques are typically implemented in a reactive manner that is hampered by inherent limitations that compromise optimal performance and user experience. Reactive throttling, however, has a delayed response that can lead to perceptible performance degradation and lag. Further, conventional threshold-based approaches may lead to overly aggressive performance reduction, sometimes throttling more than necessary.

To address these issues, techniques are described for implementing proactive thermal control for an SoC. In example aspects, an SoC includes at least one subsystem and at least one thermal-control system. The thermal-control system is a passive cooling system capable of managing heat that is generated by the subsystem to protect the subsystem from being damaged due to overheating, to maintain reliability of the SoC, and to avoid creating a potentially unsafe situation for the user to operate a computing device with the SoC. In contrast to an active cooling system (e.g., a system that consumes power to dissipate or transfer heat, such as by operating a fan), the passive cooling system does not consume power during operation and has a smaller footprint (e.g., no fans or other mechanical cooling components) than the active cooling system. Further, unlike some conventional passive-thermal-control systems, which throttle operations based on a static or fixed thermal-control policy, the proactive thermal control described herein is adaptable to various workloads and usage profiles.

Through proactive thermal control, the thermal-control system can utilize prediction telemetries to proactively update thermal-mitigation policies that manipulate the operation points of the SoC subsystems, even for contradicting goals between performance and thermal constraints (whether predefined or user-defined). In this way, the thermal-control system can control an amount of heat that is generated by the subsystem while various applications run and utilize the subsystem on the SoC.

### Operating Environment

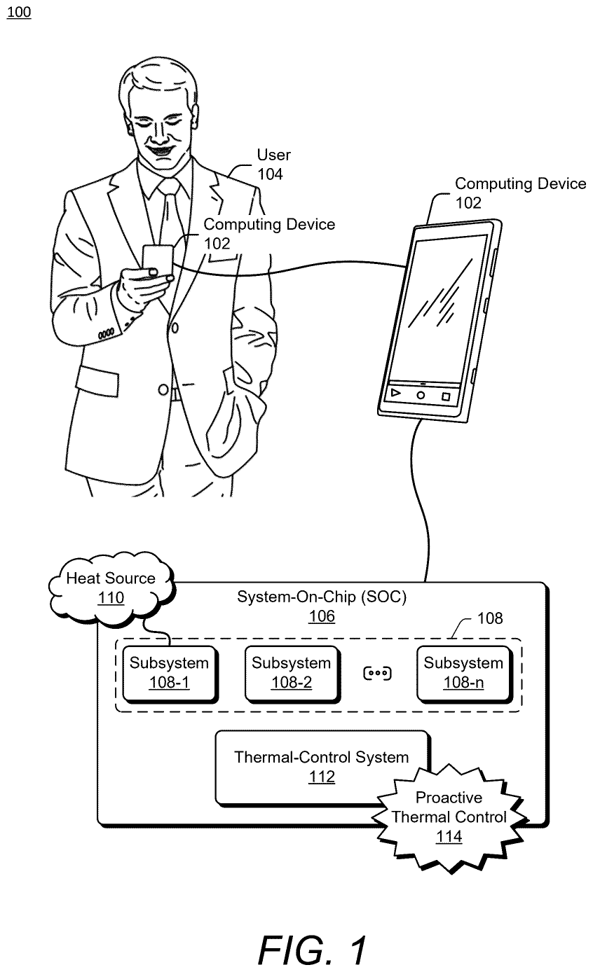

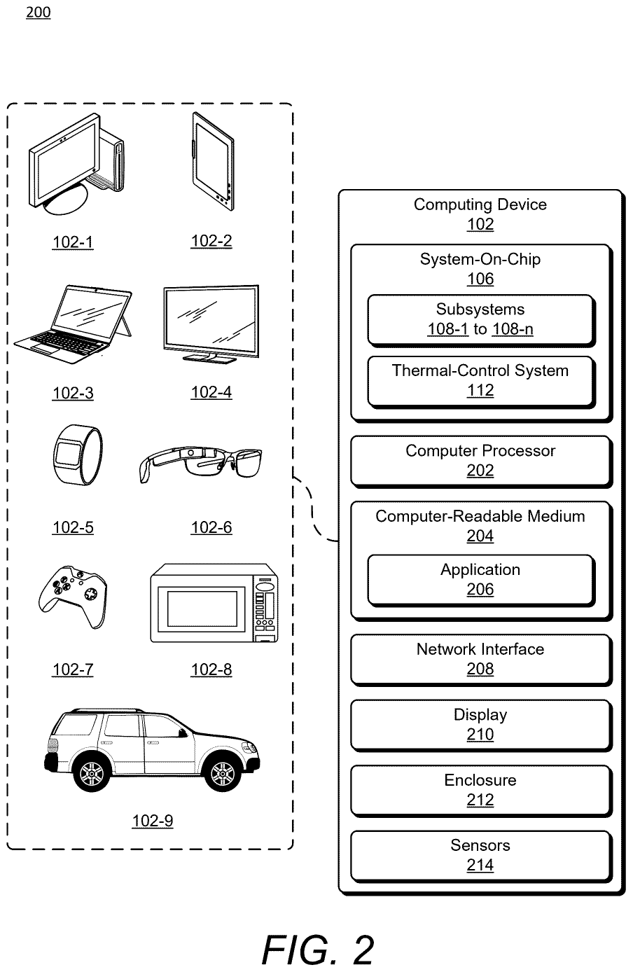

FIG. 1 is an illustration of an example environment 100 in which proactive thermal control of an SoC can be implemented. In the example environment 100, a computing device 102 provides features and/or services for a user 104. Although depicted as a smartphone, the computing device 102 can include other types of devices, including those described with respect to FIG. 2. The computing device 102 includes at least one system-on-chip 106 (SoC 106). The SoC 106 can be implemented with electronic circuitry, a microprocessor, memory, input-output (I/O) control logic, communication interfaces, firmware, and/or software useful to provide functionalities of the computing device 102.

The SoC 106 includes multiple subsystems 108-1, 108-2 . . . 108-n, where n represents a positive integer. The subsystems 108 can also be referred to as agents, modules, intellectual-property (IP) blocks, or IP cores. Example subsystems 108 can include a central processing unit (CPU), a graphics processing unit (GPU), an image processing unit (IPU), a modem, a digital signal processor (DSP), a tensor processing unit (TPU), a neural processing unit (NPU), an image processing unit (IPU), a power processing unit (PPU), a display, a speaker, a processor, a memory, a sensor, an analog circuit, a digital circuit, components that handle application-specific processing functions, and so forth.

To facilitate independent operation, the subsystems 108 can have independent clock domains, independent voltage domains, independent power domains, or some combination thereof. Variations in the clock domains, the voltage domains, and the power domains can be based on the different functionalities provided by the subsystems 108 and/or can be based on different implementations of the subsystems 108. The clock domains enable the subsystems 108 to perform operations based on clock signals that are generated by different sources (e.g., generated by different clock generators or different phase-locked loops). The clock signals associated with different clock domains can have similar or different frequencies and/or phases. The different clock domains provide additional flexibility in designing the SoC 106 and positioning the subsystems 108 within the SoC 106. For instance, with the different clock domains, the subsystems 108 can be positioned relatively far apart compared to subsystems 108 that share a same clock domain.

The voltage domains enable the subsystems 108-1 and 108-2 to use different power supply voltages. The power domains enable the subsystems 108 to independently power on or off. With the different clock domains and the different voltage domains, the subsystems 108 can utilize dynamic voltage and frequency scaling (DVFS) to facilitate thermal control of the SoC 106. With the different power domains, one or more of the subsystems 108 can also reduce heat generation by powering off when not in use.

One or more of the subsystems 108 represent a heat source 110. While operating, these subsystems 108 generate heat, which can contribute to increasing an internal temperature of the computing device 102. Left unchecked, the accumulation of heat within the computing device 102 can result in a high temperature that can damage the SoC 106, damage other components of the computing device 102, and/or reduce a reliability of the computing device 102. In some cases, the high temperature can cause the computing device 102 to become unsafe for the user 104 to operate or touch.

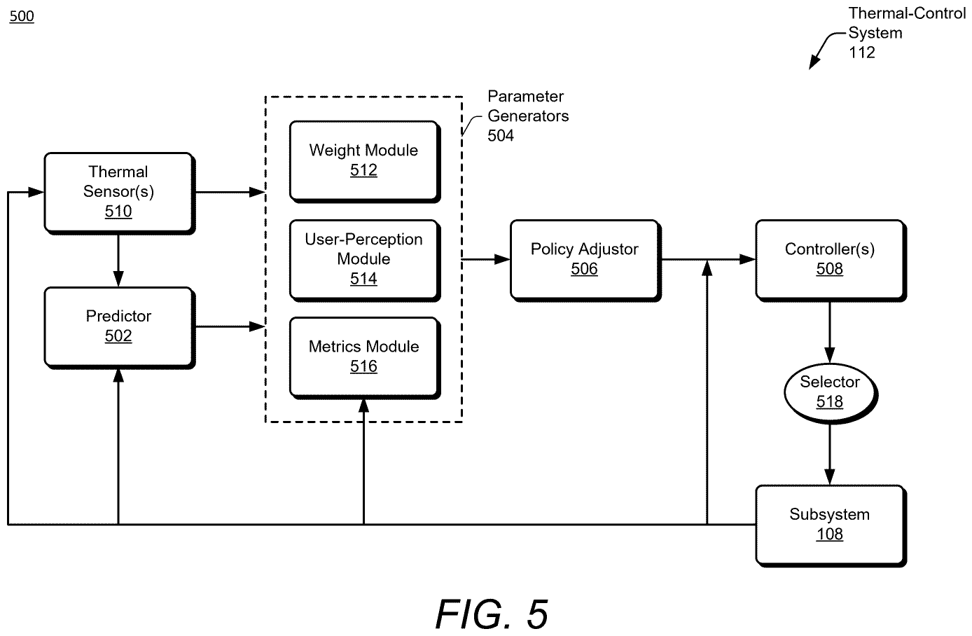

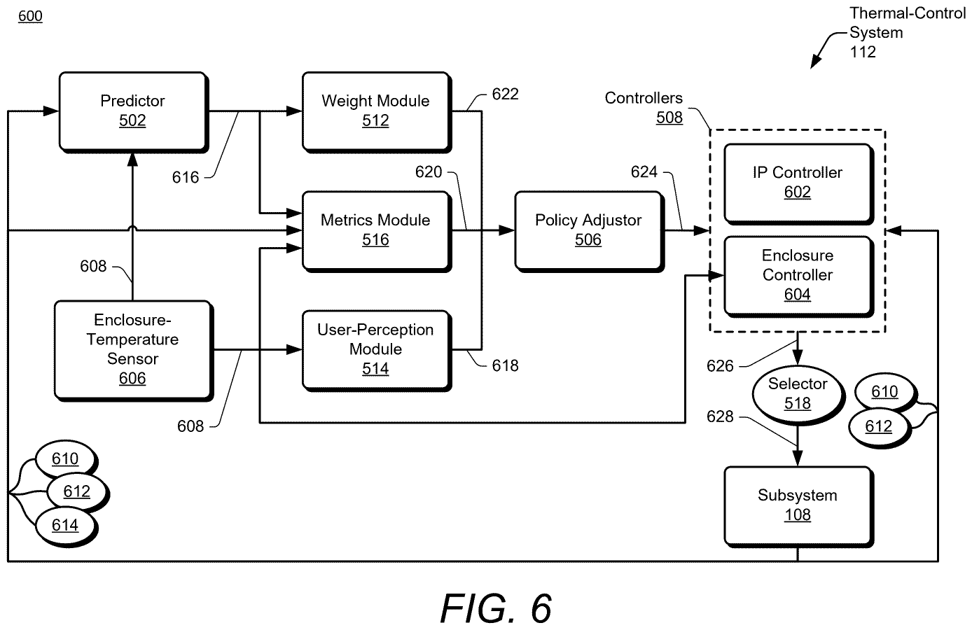

To avoid these situations, the SoC 106 includes at least one thermal-control system 112. From a high-level perspective, the thermal-control system 112 manages the thermal influence of the SoC 106 on the computing device 102's overall temperature. At a low-level perspective, the thermal-control system 112 provides proactive thermal control 114 by utilizing a prediction model to obtain a prediction of future evolution of the SoC 106 over a period of time and adjusting an operation point of one or more of the subsystems 108, based on the prediction, to control an amount of heat that is generated by those subsystems 108. The prediction is based on a variety of parameters including, for example, temperatures of different IP blocks, an enclosure temperature, power consumption of different IP blocks, and IP-block performance residency. An example implementation of the thermal-control system 112 is further described with respect to FIGS. 5 and 6.

The thermal-control system 112 can be considered another subsystem 108 of the SoC 106. In some implementations, a single thermal-control system 112 provides proactive thermal control 114 for a single subsystem 108. In other implementations, a single thermal-control system 112 provides proactive thermal control 114 for multiple subsystems 108. In still other implementations, multiple thermal-control systems 112 provide proactive thermal control 114 for different sets of subsystems 108 within the SoC 106. The components of the SoC 106 (e.g., the subsystems 108 and the thermal-control system 112) can alternatively be implemented within other types of integrated circuits or embedded systems, such as a microchip, an application-specific integrated circuit (ASIC), an application-specific standard product (ASSP), a digital signal processor (DSP), a programmable system-on-chip (PSoC), a system-in-package (SiP), a controller, and so forth. The computing device 102 is further described with respect to FIG. 2.

FIG. 2 illustrates an example implementation 200 of a computing device 102 that can implement aspects of proactive thermal control for an SoC. The computing device 102 is illustrated with various non-limiting example devices, including a desktop computer 102-1, a tablet 102-2, a laptop 102-3, a television 102-4, a computing watch 102-5, computing glasses 102-6, a gaming system 102-7, a microwave 102-8, and a vehicle 102-9. Other devices may also be used, including a hearable, a home service device, a smart speaker, a smart thermostat, a baby monitor, a Wi-Fi^{TM} router, a drone, a trackpad, a drawing pad, a netbook, an e-reader, a home automation and control system, a wall display, or another home appliance. Note that the computing device 102 can be wearable, non-wearable but mobile, or relatively immobile (e.g., desktops and appliances). The computing device 102 includes at least one SoC 106. The SoC 106 includes the subsystems 108-1 to 108-n and the thermal-control system 112, as described in FIG. 1.

The computing device 102 also includes at least one computer processor 202 and at least one computer-readable medium 204 (e.g., non-transitory computer-readable medium). The computer-readable medium 204 can include memory media and/or non-transitory storage media. An operating system (not shown) embodied as computer-readable instructions on the computer-readable medium 204 can be executed by the computer processor 202.

The computer-readable medium 204 can include one or more applications 206. Execution of the application 206 can involve operating one or more subsystems 108. Example applications 206 can include a messaging application, an application that plays videos, a navigation application, a gaming application, and the like. Different applications 206 can have different performance requirements and cause the subsystems 108 to operate with different workloads. For example, some applications 206 can utilize the first subsystem 108-1, other applications 206 can utilize the second subsystem 108-2, and still other applications 206 can utilize multiple subsystems 108 (e.g., the subsystems 108-1 and 108-2). In general, each application 206 can be associated with a particular thermal-usage characteristic, which represents an amount of heat generated by the SoC 106. This heat generation impacts an overall temperature of the computing device 102.

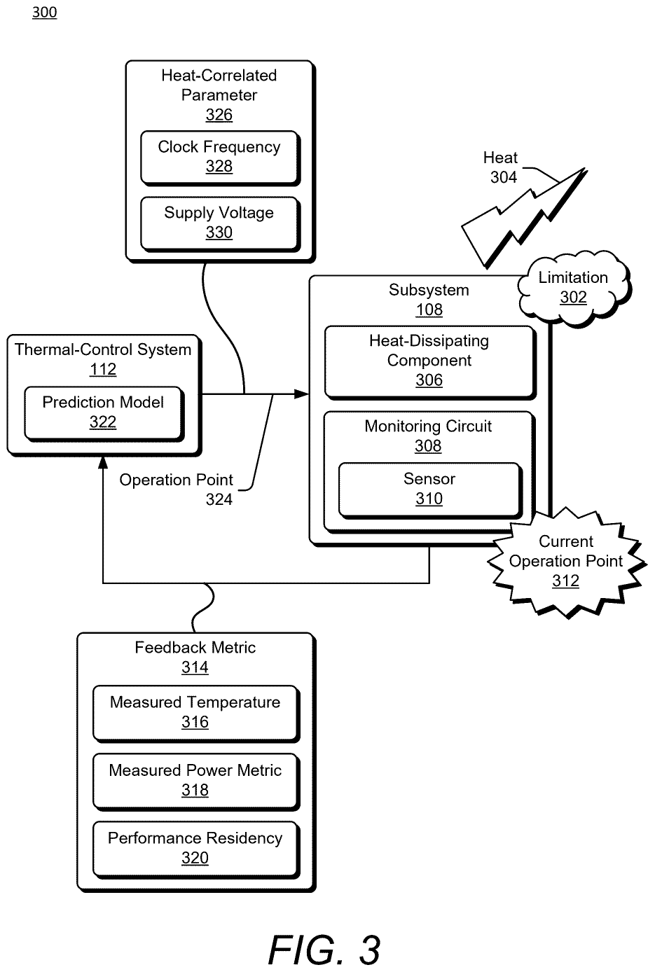

The computing device 102 can additionally include a network interface 208 for communicating data over wired, wireless, or optical networks. For example, the network interface 208 may communicate data over a local area network (LAN), a wireless local area network (WLAN), a personal area network (PAN), a wide area network (WAN), an intranet, the Internet, a peer-to-peer network, a point-to-point network, a mesh network, Bluetooth™, and the like. The computing device 102 may also include a display 210. An example relationship between the thermal-control system 112 and one of the subsystems 108 is further described with respect to FIG. 3.

The computing device 102 includes an enclosure 212 (e.g., a housing), which can be physically touched (e.g., held) by a user. In some aspects, the heat generated by the SoC 106 is transferred to the enclosure 212, which in turn dissipates the heat to the environment (e.g., air) surrounding the computing device 102. Because the user can touch the computing device 102, the surface temperature (referred to herein as the enclosure temperature) of the enclosure 212 should be maintained at or below a prescribed temperature to prevent harm to the user. Accordingly, the computing device 102 can include one or more sensors 214, such as thermal sensors (e.g., thermistors), that measure or detect temperature at specific locations on the computing device 102, including locations on the enclosure 212 or on any of the components of the computing device 102, such as the SoC 106.

FIG. 3. illustrates an example relationship 300 between the subsystem 108 and the thermal-control system 112, which are communicatively coupled together. Although a single subsystem 108 is depicted in FIG. 3, it is to be understood that the thermal-control system 112 can be coupled to more than one subsystem 108. Some subsystems 108 can have an operation limitation 302. The limitation 302 can represent an operating parameter that is not to be exceeded to avoid compromising an operation of the subsystem 108, a reliability of the subsystem 108, and/or user safety. In many cases, meeting or surpassing the limitation 302 can damage the subsystem 108 and/or decrease a reliability of the subsystem 108. Some limitations 302, such as a safety-based limitation, can represent a maximum instantaneous temperature limit. Keeping an instantaneous temperature measurement of the subsystem 108 below the maximum instantaneous temperature limit can protect the subsystem 108 from damage caused by operating at a high temperature. Other limitations 302, such as a reliability-based limitation, can represent a maximum average temperature limit. Keeping an average temperature measurement of the subsystem 108 below the maximum average temperature limit can preserve a reliability of the subsystem 108 (e.g., can avoid degrading or compromising the reliability of the subsystem 108).

The subsystem 108 is an active component and a heat source 110, which means that the subsystem 108 consumes power and generates heat 304 during operation. The subsystem 108 includes at least one heat-dissipating component 306 and at least one monitoring circuit 308. While active (e.g., while consuming power), the heat-dissipating component 306 generates heat 304, which can contribute to the overall internal temperature of the computing device 102. Example heat-dissipating components 306 can include an integrated circuit, a transistor, a resistor, a processor, and so forth.

The monitoring circuit 308 provides information regarding an operation of the subsystem 108 (e.g., an operation of the heat-dissipating component 306) to the thermal-control system 112. In some implementations, the monitoring circuit 308 includes at least one sensor 310 (e.g., sensor 214), which measures a temperature associated with the subsystem 108. The sensor 310 can be positioned on or proximate to the heat-dissipating component 306. In some cases, the monitoring circuit 308 includes multiple temperature sensors 310 to measure the temperature associated with the heat-dissipating component 306. The monitoring circuit 308 can measure or determine other operating parameters of the heat-dissipating component 306 (or more generally of the subsystem 108). For example, in some implementations, the monitoring circuit 308 can measure an amount of power that is consumed by the heat-dissipating component 306.

During operation, the subsystem 108 operates at a current operation point 312. The current operation point 312 represents a current configuration of the subsystem 108. In example implementations, the current operation point 312 can specify one or more heat-correlated parameters of the subsystem 108, examples of which are further described below.

To enable the thermal-control system 112 to proactively control an operation point of the subsystem 108 and manage the generation of heat 304, the monitoring circuit 308 generates at least one feedback metric 314 based on an operation of the subsystem 108 at the current operation point 312. The subsystem 108 passes the feedback metric 314 to the thermal-control system 112. The feedback metric 314 includes at least a measured temperature 316 associated with the subsystem 108. The measured temperature 316 can represent an instantaneous temperature that is measured by the sensor 310. In the case of multiple temperature sensors 310, the measured temperature 316 can represent an average or maximum of the instantaneous temperatures measured by the multiple temperature sensors 310.

In some implementations, the monitoring circuit 308 also monitors and reports a measured power metric 318 of the subsystem 108. The measured power metric 318 can represent an instantaneous amount of power that is consumed by the subsystem 108 or an average amount of power that is consumed by the subsystem 108 over a given time interval.

In some implementations, the monitoring circuit 308 also monitors and reports a performance residency 320 of the subsystem 108. Residency is a statistical measure for reporting history (e.g., past values) over a period of time. For example, the performance residency 320 can indicate, relatively, a percentage of time that the operation point stays at a particular voltage and/or frequency compared to other voltages and/or frequencies.

In aspects, the thermal-control system 112 implements a prediction model 322 to provide a prediction associated with the subsystem 108, such as estimated future behavior of the subsystem 108 (e.g., estimated power profile, estimated performance level, estimated temperature) over a period of time based on its current power profile and temperature. Using the prediction along with live calculated metrics (e.g., power, thermal) and weighted-metric thresholds, the thermal-control system 112 can proactively update a thermal-control policy (e.g., thermal-mitigation policy) that manipulates the operation point of the subsystem 108.

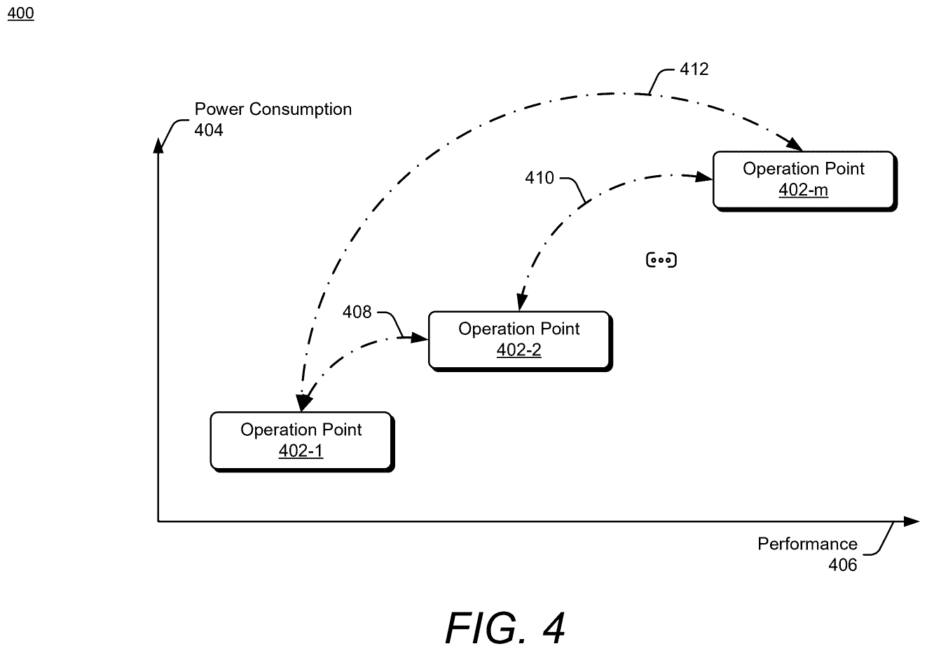

The thermal-control system 112 generates a new operation point 324 based on the feedback metric 314. The new operation point 324 specifies at least one heat-correlated parameter 326 (e.g., a heat-correlated operation parameter 326) of the subsystem 108. Example heat-correlated parameters 326 include a clock frequency 328 and a supply voltage 330. If the subsystem 108 represents or includes the display 210, the heat-correlated parameter 326 (e.g., frequency, voltage) can directly correlate to a brightness of the display 210. In the case that the subsystem 108 includes a speaker, the heat-correlated parameter 326 (e.g., frequency, voltage) can directly correlate to an output volume. In another example, the heat-correlated parameters 326 can correlate to a transmit power associated with a transmitter. In many cases, the heat-correlated parameter 326 has a direct relationship with the heat 304 that is generated by an operation of the subsystem 108. For example, increasing any one of the clock frequency 328 or the supply voltage 330 can increase an amount of heat 304 that is generated by the subsystem 108. By controlling the operation point of the subsystem 108 in a predictive way, the thermal-control system 112 can provide proactive thermal control 114 for the SoC 106. Different operation points can be associated with different levels of power consumption and different levels of performance, as further described with respect to FIG. 4.

FIG. 4 illustrates a graph 400 of example operation points 402 of the subsystem 108. In this example, the subsystem 108 can operate at any one of the operation points 402-1, 402-2 . . . 402-m, where m represents a positive integer. The graph 400 depicts an example relationship between the operation points 402 in terms of power consumption 404 and performance 406. Higher levels of performance 406 can enhance a user experience while lower levels of performance 406 can degrade the user experience.

In general, there is a direct relationship between power consumption 404 and performance 406. Operation points 402 associated with higher levels of power consumption 404 are also associated with higher levels of performance 406. Operation points 402 associated with lower levels of power consumption 404 are also associated with lower levels of performance 406. There is also a direct relationship between power consumption 404 and heat generation. Operation points 402 associated with higher levels of power consumption 404 are also associated with higher levels of heat generation. In contrast, operation points 402 associated with lower levels of power consumption 404 are associated with lower levels of heat generation.

The first operation point 402-1 consumes a first amount of power and provides a first level of performance. The operation point 402-2 consumes a second amount of power and provides a second level of performance. The second amount of power is greater than the first amount of power. Also, the second level of performance is higher than the first level of performance. The operation point 402-m consumes a third amount of power and provides a third level of performance. The third amount of power is greater than the second amount of power. Also, the third level of performance is higher than the second level of performance.

By proactively changing the operation point 402 of the subsystem 108, the thermal-control system 112 can adapt to various workloads and usages of the subsystem 108 in a predictive manner while ensuring safety and/or reliability of the SoC 106. In various situations, the thermal-control system 112 can adjust the operation point 402 of the subsystem 108 in a slow, gradual manner or a fast, sudden manner. Consider a case in which the subsystem 108 can selectively operate at one of the three operation points 402-1, 402-2, and 402-m. In a first example situation, the thermal-control system 112 gradually changes the operation point 402 of the subsystem 108, such as by causing the subsystem 108 to transition between the operation points 402-1 and 402-2 as indicated at 408, or by causing the subsystem 108 to transition between the operation points 402-2 and 402-m as indicated at 410. In these examples, the change in the operation point 402 causes a relatively small change in the power consumption 404 and the performance 406 of the subsystem 108. This gradual change in the operation point 402 can allow for a better user experience as the user 104 may not notice the incremental change in performance 406.

In a second example situation, the thermal-control system 112 significantly changes the operation point 402 of the subsystem 108, such as by causing the subsystem 108 to transition between the operation points 402-1 and 402-m as indicated at 412. In this example, the change in the operation point 402 causes a relatively large change in the power consumption 404 and the performance 406 of the subsystem 108. This type of situation can occur if an operation of the subsystem 108 is approaching the limitation 302 and the thermal-control system 112 has to severely throttle an operation of the subsystem 108. As another example, this situation can occur if a predicted change in the usage of the subsystem 108 indicates that the thermal-control system 112 can lift previously enacted throttling restrictions to enhance the user experience.

FIG. 5 illustrates an example implementation 500 of the thermal-control system 112 for an SoC. In the illustrated example, the thermal-control system 112 includes a predictor 502, one or more parameter generators 504, and a policy adjustor 506. In aspects, the thermal-control system 112 also includes, or is in communication with, one or more controllers 508, one or more subsystems 108, and one or more thermal sensors 510. The parameter generators 504 can include at least one of a weight module 512, a user-perception module 514, a metrics module 516, or the like.

Generally, the predictor 502 receives input from the subsystem 108 and, in some cases, the thermal sensor 510. Such input can include the feedback metrics 314 from FIG. 3, such as the measured temperature 316, the performance residency 320, and the measured power metric 318 of the subsystem 108. In some implementations, the predictor 502 also receives temperature measurements from the thermal sensor(s) 510, which may correspond to the temperature of other components of the computing device 102, such as the enclosure 212. Based on these inputs, which represent a current usage profile of the subsystem 108, the predictor 502 generates a prediction (estimation, interpolation, etc.) of a future evolution of the subsystem 108 over a period of time. The prediction can include an estimation of a future temperature and a future power profile of the subsystem 108 over the period of time based on the current usage profile. In some implementations, the prediction can also include an estimation of a future temperature of the other component(s) associated with the temperature measurement provided by the thermal sensors 510.

In aspects, the predictor 502 is a prediction model that is trained using a variety of use cases covering an ensemble of user interactions with the SoC 106. This training includes stressing the SoC with skewed workloads (power centric on one subsystem), balanced workloads (power distributed to multiple subsystems), and power viruses that extensively demand aggressive power consumption. The trained model can also be adapted during normal SoC operation to generalize for future use cases and address potential performance boosts that have user-experience implications. The values (e.g., power, temperature) of the prediction highlight the SoC 106 (and in larger scale the formfactor that includes the SoC 106) dynamics at different time scales. For example, the enclosure temperature changes in a slower time scale compared to SoC die temperatures.

The prediction is provided to the parameter generators 504. In some implementations, the thermal sensor(s) 510 also provide the temperature measurement(s) to the parameter generators 504. The parameter generators 504 generate parameters that are used as inputs to the policy adjustor 506 to enable the policy adjustor 506 to generate an appropriate control policy for the controller(s) 508.

This variability in prediction dynamics (e.g., time scales) is employed by the weight module 512 for monitoring contradicting goals, which include peak/bursty performance, sustained performance, and thermal (safety and reliability) constraints. The weight module 512 uses the prediction values and generates weighted-metric thresholds for the policy adjustor 506. These thresholds may be related to power metrics and temperature metrics. In aspects, the limits generated by the weight module 512 represent thresholds that, if exceeded, may result in unsafe conditions and/or damage to the subsystem 108. In some cases, the limits also include limits associated with the temperature of the enclosure that, if exceeded, may result in discomfort or harm to the user touching the computing device 102. The weight module 512 considers the tradeoffs between peak performance duration and filtered SoC temperature residency at different time scales. Temperature residency can indicate, relatively, a percentage of time that a specific temperature is sustained above a particular temperature limit or threshold. In implementations, the weight module 512 determines the temperature residency time limit associated with different time scales. The weight module 512 can also produce enclosure-temperature limits. Depending on the application, there may be different enclosure-temperature limits that require different thermal-mitigation efforts. In some aspects, depending on the predicted temperature and power, the weight module 512 may enforce ambitious performance tracking (by providing higher temperature, power, and residency bounds/targets) to enable a higher margin for an elevated user experience even though a predicted high-power residency or high-temperature residency may indicate a need for a tighter mitigation enforcement to meet thermal constraints, safety constraints, or regulatory constraints.

The user-perception module 514 represents feedback (e.g., thermal-perception feedback) from the user that indicates a user perception of, for example, a thermal limit (e.g., maximum) of a surface temperature of the enclosure relative to the user's personal preference or comfort level. Such feedback can be used as a tradeoff against the user's preference for a performance level of the computing device 102. For example, a first user may be more sensitive to touching a hot surface than a second user, such that the first user may indicate that a first enclosure temperature (e.g., 45° C.) is a maximum comfort level or a pain threshold, whereas the second user may indicate that a second, lower enclosure temperature (e.g., 40° C.) is too hot for comfort or is painful. Accordingly, the first user may place more value on device performance than on device temperature but the second user may value their comfort level more than a high-performance, hot device. Accordingly, the user-perception module 514 enables the thermal-control system 112 to adapt to the user's personal preferences.

The metrics module 516 provides metrics for various constraints of the subsystem 108. The metrics module 516 receives input including, for example, prediction input values (e.g., the prediction from the predictor 502), which may include a predicted subsystem temperature, predicted power, predicted performance residency, predicted enclosure temperature, and the like. In one implementation, the metrics module 516 is configured to average data (e.g., measurements, telemetries) over different time scales, where the time scale is determined based on the prediction input values. For example, a high ramp rate in a future temperature may indicate that a fast filtering mechanism should be employed to capture current dynamics to facilitate making informed decisions by the policy adjustor 506. This high-ramp-rate metric may, for example, alarm the policy adjustor 506 to make appropriate thermal-throttling decisions. In aspects, the computing device 102 can include dedicated memory spaces to continue calculating the metrics for live thermal-control policy manipulation.

The policy adjustor 506 compares the metrics (power/thermal/performance related metrics) against the limits provided by the weight module 512. Such comparisons may lead to manipulation of currently enforced thermal-mitigation policies. The policy adjustor 506 uses the output of the user-perception module 514 as thermal-perception feedback indicating the user perception of, feeling of, or preference for the enclosure temperature. In some implementations, the computing device 102 can prompt the user to provide user input as the thermal-perception feedback. Such feedback is used to manipulate the thermal-mitigation policy and in particular thermal-control policies for sustained (long-term) performance.

Thermal-policy enforcement occurs in a variety of ways including, for example, updating temperature and power controllers, changing feedback-filter time constants for different controllers, or changing controller mapping-table entries. The policy enforcement implemented by the policy adjustor 506 ensures performance (peak/sustained) targets are met through considering goals, even contradicting goals. For example, the policy adjustor 506 may sacrifice a high-peak performance up to a certain limit to ensure a pre-specified, sustained performance target. In aspects, an enclosure-temperature prediction may provide an indication of approaching higher thermal constraints, which are prone to more-severe mitigation techniques that have performance implications. In some implementations, the policy adjustor 506 utilizes the enclosure-temperature metrics to proactively limit power/temperature ramp rate while monitoring performance metrics. On the other hand, the policy adjustor 506 can slow down a currently enforced thermal-mitigation policy to boost instantaneous performance or abruptly activate more-severe mitigation techniques to meet thermal-safety constraints. After manipulation of the different controllers 508, each controller 508 can provide a proposed value as a candidate for a new operation point of the subsystem 108. In some implementations, selector logic 518 selects a minimum of the proposed values, which meets the thermal/power requirements, for enforcement.

FIG. 6 illustrates an example implementation 600 (e.g., use case) of the thermal-control system 112 for an SoC. In the example implementation 600, the thermal-control system 112 utilizes multiple controllers 508 that each attempt to control the power drawn and heat generated by the subsystem 108 (e.g., CPU, GPU, TPU, IPU) by changing the operation point of the subsystem 108. The illustrated example includes an IP controller 602 and an enclosure controller 604. The IP controller 602 is configured to determine a proposed operation point for the subsystem 108 (e.g., IP core) based on various inputs including, for example, an SoC temperature (e.g., die temperature) of the subsystem 108. The enclosure controller 604 is configured to determine a proposed operation point for the subsystem 108 based on various inputs including, for example, an enclosure temperature (e.g., surface temperature of the enclosure 212 of the computing device 102). Because the inputs are different for each controller, the proposed operation points may also be different from one another. For example, the IP controller 602 can generate a first proposed operation point that defines a first voltage and a first frequency, and the enclosure controller 604 can generate a second proposed operation point that defines a second voltage and a second frequency, where the second voltage and the second frequency are different from the first voltage and the first frequency, respectively.

To implement proactive thermal control of the SoC in the example implementation 600, the thermal-control system 112 utilizes one or more enclosure-temperature sensors 606 (e.g., sensor 214) configured to measure the temperature of the enclosure 212. The enclosure-temperature sensor 606 provides a measured value of the enclosure temperature 608 to the predictor 502, the metrics module 516, the user-perception module 514, and the enclosure controller 604.

The predictor 502 receives the enclosure temperature 608 from the enclosure-temperature sensor 606 and also receives feedback from the subsystem 108, which includes an IP temperature 610 representing a current temperature (e.g., the measured temperature 316) of the subsystem 108. The feedback from the subsystem 108 can also include power 612 (e.g., power being currently consumed by the subsystem 108) and a performance residency 614 associated with a current operation point (e.g., the current operation point 312) of the subsystem 108. The power 612 is an example of the measured power metric 318 in FIG. 3 and the performance residency 614 is an example of the performance residency 320 in FIG. 3. Using these inputs, the predictor 502 generates a prediction 616 of the future evolution of the subsystem 108, where the prediction 616 includes at least a future IP temperature (e.g., future die temperature), a future enclosure temperature, and a future power profile. The prediction 616 provides an estimation of the future usage of the subsystem 108 over a period of time (e.g., 1 second(s), 5 s, 10 s, 20 s, 30 s) based on the current usage.

In some aspects, the predictor 502 can be a fixed prediction model or an adaptable prediction model. The predictor 502 can be updated via an updated model, a replacement model, etc., or the predictor 502 can be updated via further training. In one example, an error measure can be used to monitor the difference or disparity between the future IP temperature and the current temperature over time. If the difference between the future IP temperature and the current temperature is ramping up (e.g., increasing) over time, then the model likely needs to be updated because the prediction is becoming less reliable.

The user-perception module 514 can be implemented to initiate a prompt to the user if, for example, the enclosure temperature exceeds a threshold. The user can provide an input to indicate whether the enclosure temperature is too hot for them (e.g., uncomfortable, painful) to touch. Such user input helps tailor the user experience to the particular user. For example, based on the user input (e.g., from a first user), the user-perception module 514 can determine that, for the first user, an enclosure temperature of, for example, 43° C. is acceptable. Based on a different user input (e.g., from a second user), the user-perception module 514 can determine that, for the second user, an enclosure temperature of, for example, 40° C. is not acceptable because it is too hot and uncomfortable for the second user. The user-perception module 514 provides a user feedback 618 to the policy adjustor 506 based on the user input.

The metrics module 516 receives various inputs. In an example, the metrics module 516 receives the enclosure temperature 608, the IP temperature 610, the power 612, the performance residency 614, and the prediction 616 (e.g., future IP temperature, future power profile, and future enclosure temperature). The metrics module 516 uses these inputs to calculate metrics 620, which represent constraints, or limits, for the system to avoid damaging the electronics. One example metric includes filtered power or average power. Based on the electronic specs of the system, the average of the power cannot be greater than a threshold over a certain duration of time, otherwise the transistors may be damaged or the lifetime of the device may be affected. Another example includes power consumption, which has a relation to a battery of the electronic device 102 and risks browning out the battery if power is drawn over a certain ramp rate. The metrics module 516 calculates the metrics (e.g., average power, filtered power, filtered or average enclosure temperature, filtered or average IP temperature) and provides the metrics to the policy adjustor 506.

The weight module 512 receives the prediction 616 from the predictor 502 and applies weight factors 622 (e.g., thresholds or limits) for the metrics. For example, using the future IP temperature, the future enclosure temperature, and the future power profile, the weight module 512 provides the weight factors 622, which can include an IP-temperature limit, an enclosure-temperature limit, a power limit, an IP-temperature-residency limit, and an enclosure-temperature-residency limit. These outputs are provided to the policy adjustor 506.

The policy adjustor 506 uses the outputs from the weight module 512, the metrics module 516, and the user-perception module 514 as inputs to determine tradeoffs and contradicting goals. For example, some users tend to value high frames-per-second (fps) in a video game to ensure that the graphical user experience is as great as possible and may care less about the enclosure temperature becoming hot. In another example, some users place less value on fps quality in a phone call or video call and a higher value on maintaining the call (not dropping the call or not losing content). Such contradicting goals indicate different requirements for the power and the temperature. For example, for a video game, the prediction 616 can estimate that a currently high fps (and corresponding high power consumption and high temperature) will likely finish in about 10 seconds. The policy adjustor 506 can determine not to throttle the system over the next 10 seconds even though the enclosure temperature may exceed a threshold during that time. Such a determination can also be based on the IP-temperature-residency limit and the enclosure-temperature-residency limit, which provide indications of how much time the IP temperature and enclosure temperature, respectively, can be sustained over the limits.

The policy adjustor 506 uses the inputs to determine a thermal-control policy 624 for each of the controllers 508. In an example, the policy adjustor 506 generates a thermal-control policy 624 to cause a CPU temperature controller (e.g., IP controller 602) to control the CPU temperature to a particular level by defining a temperature target (e.g., an IP-temperature target). The policy adjustor 506 can also determine a cadence for each of the controllers 508 based on the metrics 620, the user feedback 618, and the weight factors 622. The cadence can define a frequency for the controller 508 to monitor the thermal-control policy 624. For example, the thermal-control policy 624 can define a cadence (e.g., IP-controller cadence) for the IP controller 602 to cause the IP controller 602 to monitor the thermal-control policy 624 every certain number of milliseconds (ms) (e.g., 1 ms, 2 ms, 5 ms, 10 ms, 50 ms). Accordingly, the thermal-control policy 624 can change based on the prediction and the calculated metrics. Similarly, the thermal-control policy 624 can define a temperature target and cadence for the enclosure controller 604, such as an enclosure-temperature target and an enclosure-controller cadence.

Based on the thermal-control policy 624, the IP controller 602 and the enclosure controller 604 each provide a proposed operation point 626 for the subsystem 108. For example, the IP controller 602 provides a first proposed operation point and the enclosure controller 604 provides a second proposed operation point. The selector logic 518 selects one of the proposed operation points 626 and passes a selected operation point 628 to the subsystem 108 for enforcement. In one example, the selector logic 518 selects the minimum operation point of the proposed operation points 626 to send to the subsystem 108 for enforcement, which can ensure that the thermal and power requirements for both (including all) controllers 508 are met. Alternatively, the selector logic 518 can interpolate (e.g., average) an operation point between the proposed operation points 626, depending on the situation.

The subsystem 108 enforces the selected operation point 628. The subsystem 108 continues to provide feedback (e.g., IP temperature 610, power 612, performance residency 614) so the thermal-control system 112 can continue to enforce proactive thermal control.

### Example Methods

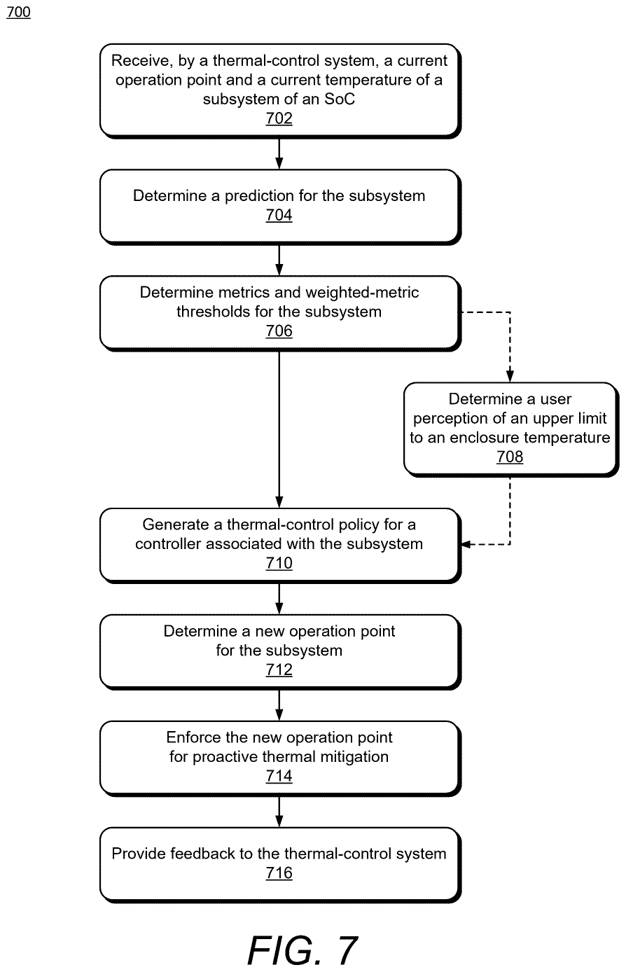

FIG. 7 depicts an example method 700 for implementing aspects of proactive thermal control of an SoC. The method 700 is shown as a set of operations (or acts) performed but not necessarily limited to the order or combinations in which the operations are shown herein. Further, any of one or more of the operations may be repeated, combined, reorganized, or linked to provide a wide array of additional and/or alternate methods. In portions of the following discussion, reference may be made to the environment 100 of FIG. 1, and entities and components detailed in FIGS. 1-6, reference to which is made for example only. The techniques are not limited to performance by one entity or multiple entities operating on one device.
FIG. 7 illustrates an example method 700 for performing proactive thermal control for an SoC. At 702, a current operation point and a current temperature of a subsystem of an SoC are received. For example, the predictor 502 receives feedback from the subsystem 108, which includes the IP temperature 610, the power 612 currently being drawn by the subsystem 108, and the performance residency 614 associated with the current operation point of the subsystem 108. In some examples, the predictor 502 also receives the enclosure temperature 608 from one or more of the enclosure-temperature sensors 606.

At 704, a prediction is determined for the subsystem. For example, the predictor 502 generates the prediction 616 based on the IP temperature 610, the power 612, and the performance residency 614. In some examples, the predictor 502 also uses the enclosure temperature 608 to generate the prediction 616. In implementations, the prediction 616 includes a future IP temperature and a future power profile over a period of time. In some examples, the prediction 616 also includes a future enclosure temperature over the period of time.

At 706, metrics and weighted-metric thresholds are determined for the subsystem. For example, the metrics module 516 can calculate the metrics 620, which represent constraints for the system to avoid damaging the electronics. Example metrics include average power, filtered power, filtered or average enclosure temperature, filtered or average IP temperature, etc. The metrics module 516 calculates the metrics 620 based on various inputs, including, for example, the enclosure temperature 608, the IP temperature 610, the power 612, the performance residency 614, and the prediction 616 (e.g., future IP temperature, future power profile, and future enclosure temperature). In addition, the weight module 512 can provide weight factors 622 based on the prediction 616. The weight factors 622 define thresholds for the metrics and can include an IP-temperature limit, an enclosure-temperature limit, a power limit, an IP-temperature-residency limit, and/or an enclosure-temperature-residency limit.

In one example, which may be optional, at 708, a user perception of an upper limit to an enclosure temperature is determined. The user perception can be received via a user input that is responsive to a user prompt requesting the user to indicate a preference for an upper limit to the enclosure temperature. In some cases, the user perception can differ significantly from one user to another. In some cases, the user perception can differ significantly from metrics defining a maximum enclosure temperature.

At 710, a thermal-control policy for a controller associated with the subsystem is determined. For example, the policy adjustor 506 generates a thermal-control policy for each (one or more) controller 508 associated with the subsystem 108. The respective thermal-control policies can be different (e.g., individual) for each controller 508.

At 712, a new operation point for the subsystem is determined. For example, each controller 508 provides a proposed operation point based on its individual thermal-control policy and its particular inputs. The selector logic 518 then selects one of the proposed operation points as a new operation point for the subsystem 108. In some aspects, the selector logic 518 can select the minimum operation point of the proposed operation points to ensure that thermal and power requirements for all of the controllers are met. Alternatively, the selector logic 518 can select an operation point between the maximum and minimum of the proposed operation points.

At 714, the new operation point is enforced for proactive thermal mitigation. For example, the subsystem 108 receives the new operation point selected by the selector logic 518 and enforces the new operation point.

At 716, the subsystem provides feedback to the thermal-control system The feedback includes, for example, new measurements for the IP temperature 610, the power 612 currently being drawn by the subsystem 108, and the performance residency 614 associated with the new operation point of the subsystem 108.

### Example Computing System

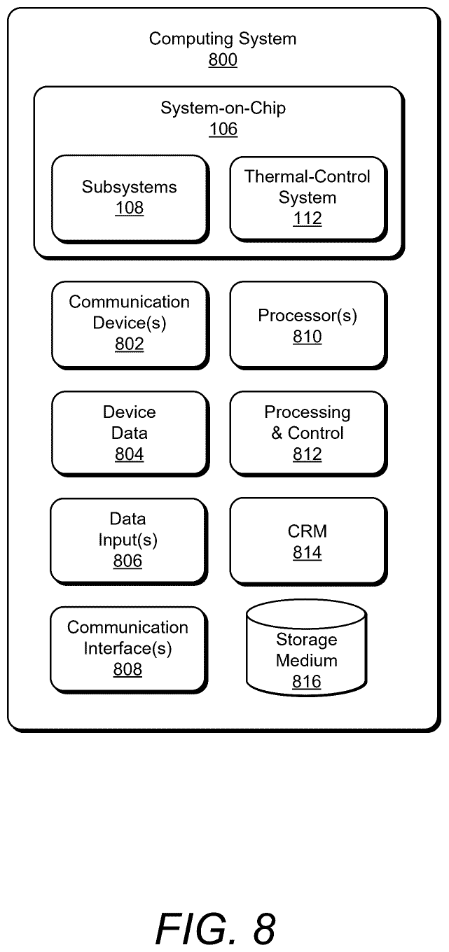

FIG. 8 illustrates an example computing system 800 embodying, or in which techniques may be implemented that enable use of, proactive thermal control for an SoC 106. The example computing system 800 illustrates various components of the example computing system 800 that can be implemented as any type of client, server, and/or computing device as described with reference to the previous FIGS. 1-7 to implement aspects of proactive thermal control for a subsystem.

The computing system 800 (e.g., the computing device 102) includes communication devices 802 that enable wired and/or wireless communication of device data 804 (e.g., received data, data that is being received, data scheduled for broadcast, or data packets of the data). The device data 804 or other device content can include configuration settings of the device, media content stored on the device, and/or information associated with a user of the device. Media content stored on the computing system 800 can include any type of audio, video, and/or image data. The computing system 800 includes one or more data inputs 806 via which any type of data, media content, and/or inputs can be received.

The computing system 800 also includes communication interfaces 808, which can be implemented as any one or more of a serial and/or parallel interface, a wireless interface, any type of network interface, a modem, and any other type of communication interface. The communication interfaces 808 provide a connection and/or communication links between the computing system 800 and a communication network by which other electronic, computing, and communication devices communicate data with the computing system 800.

The computing system 800 includes one or more processors 810 (e.g., any of microprocessors, controllers, and the like), which process various computer-executable instructions to control the operation of the computing system 800. Alternatively or in addition, the computing system 800 can be implemented with any one or combination of hardware, firmware, or fixed logic circuitry that is implemented in connection with processing and control circuits, which are generally identified at 812. Although not shown, the computing system 800 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

The computing system 800 also includes a computer-readable medium 814 (CRM 814), such as one or more memory devices that enable persistent and/or non-transitory data storage (i.e., in contrast to mere signal transmission), examples of which include random access memory (RAM), non-volatile memory (e.g., any one or more of a read-only memory (ROM), flash memory, erasable programmable read-only memory (EPROM), electrically erasable programmable read-only memory (EEPROM), etc.), and a disk storage device. The disk storage device may be implemented as any type of magnetic or optical storage device, such as a hard disk drive, a recordable and/or rewriteable compact disc (CD), any type of a digital versatile disc (DVD), and the like. The computing system 800 can also include a mass storage medium device (storage medium) 816.

The computer-readable medium 814 provides data storage mechanisms to store the device data 804, as well as various device applications and any other types of information and/or data related to operational aspects of the computing system 800. For example, an operating system can be maintained as a computer application with the computer-readable medium 814 and executed on the processors 810. The device applications may include a device manager, such as any form of a control application, a software application, a signal-processing and control module, code that is native to a particular device, a hardware abstraction layer for a particular device, and so on.

The computing system 800 also includes at least one SoC 106. The SoC 106 includes one or more subsystems 108 (e.g., CPU, GPU, TPU, IPU) and at least one thermal-control system 112. In some implementations, the processor 810, the processing and control 812, the computer-readable medium 814, and/or the storage medium 816 can represent one or more subsystems 108 of the SoC 106.

### Conclusion

Although techniques using, and apparatuses including, proactive thermal control for a system-on-chip have been described in language specific to features and/or methods, it is to be understood that the subject of the appended claims is not necessarily limited to the specific features or methods described. Rather, the specific features and methods are disclosed as example implementations of proactive thermal control for a system-on-chip.

What is claimed is:

1. A method performed by a system-on-chip, the method comprising:
obtaining, by a thermal-control system of the system-on-chip, a prediction indicating an estimation of a future temperature of a subsystem of the system-on-chip based on a current operation point and a current temperature of the subsystem;
generating, by a policy adjustor of the thermal-control system and based on the prediction, a thermal-control policy for a controller associated with the subsystem, the thermal-control policy defining a temperature target and a cadence for the controller;
determining, by the controller, a new operation point for the subsystem based on the thermal-control policy; and
enforcing, by the subsystem, the new operation point for proactive thermal mitigation.

2. The method of claim 1, wherein generating the thermal-control policy is further based on a user input indicating a user perception of an upper limit to an enclosure temperature of an enclosure of a device having the system-on-chip.

3. The method of claim 2, wherein generating the thermal-control policy includes generating a different thermal-control policy for each controller of a plurality of controllers associated with the subsystem.

4. The method of claim 3, wherein generating the different thermal-control policy for each controller of the plurality of controllers associated with the subsystem includes:
generating a first cadence and a first temperature target for a first controller of the plurality of controllers, the first cadence defining a first frequency for the first controller to monitor the thermal-control policy; and
generating a second cadence and a second temperature target for a second controller of the plurality of controllers, the second cadence defining a second frequency for the second controller to monitor the thermal-control policy.

5. The method of claim 3, wherein:
the plurality of controllers includes a first controller and a second controller; and
determining a new operation point includes:
determining, by the first controller, a first proposed operation point for the subsystem based on at least a die temperature of the system-on-chip;
determining, by the second controller, a second proposed operation point for the subsystem based at least on the enclosure temperature of the enclosure; and
selecting the new operation point from the first and second proposed operation points to pass to the subsystem for enforcement, the new operation point selected to ensure that thermal and power requirements are met for both the first controller and the second controller.

6. The method of claim 5, wherein selecting the new operation point includes selecting a minimum operation point from the first and second proposed operation points.

7. The method of claim 5, wherein:
obtaining the prediction includes obtaining a future die temperature of the subsystem, a future power profile of the subsystem, and a future enclosure temperature of the enclosure; and
the prediction is based on the current temperature of the subsystem, a current power profile of the subsystem, a performance residency associated with the current operation point of the subsystem, and the enclosure temperature of the enclosure.

8. The method of claim 2, further comprising determining metrics and weighted-metric thresholds for the subsystem based on the prediction.

9. The method of claim 8, further comprising:
determining, by the policy adjustor, tradeoffs between the metrics, the weighted-metric thresholds, and the user perception of the upper limit to the enclosure temperature; and
determining the thermal-control policy based on the tradeoffs.

10. The method of claim 8, wherein determining the metrics includes calculating at least one of an average power, a filtered power, a filtered enclosure temperature, an average enclosure temperature, a filtered IP temperature, or an average IP temperature.

11. The method of claim 10, wherein determining the weighted-metric thresholds includes determining weight factors to limit the metrics, the weight factors including an IP-temperature limit, an enclosure-temperature limit, a power limit, an IP-temperature-residency limit, and an enclosure-temperature-residency limit.

12. The method of claim 1, wherein:
obtaining the prediction includes obtaining a future die temperature of the subsystem and a future power profile of the subsystem; and
the prediction is determined by a prediction model and is based on the current temperature of the subsystem, a current power profile of the subsystem, and a performance residency associated with the current operation point of the subsystem.

13. A system-on-chip comprising:
at least one subsystem; and
at least one thermal-control system coupled to the at least one subsystem, the at least one thermal-control system including:
a predictor configured to generate a prediction indicating an estimation of a future temperature of the at least one subsystem based on a current operation point and a current temperature of the at least one subsystem;
one or more controllers configured to generate proposed operation points for the at least one subsystem;
a policy adjustor configured to generate, based on the prediction, a thermal-control policy for the one or more controllers associated with the at least one subsystem, the thermal-control policy defining a temperature target and a cadence for the one or more controllers; and
a selector logic configured to select one operation point from the proposed operation points to be enforced by the subsystem for proactive thermal mitigation.

14. The system-on-chip of claim 13, further comprising a user-perception module configured to provide, based on a user input, a user perception of an upper limit to an enclosure temperature of an enclosure of a device having the system-on-chip.

15. The system-on-chip of claim 14, wherein:
the one or more controllers include a first controller and a second controller;
the first controller is configured to determine a first proposed operation point for the subsystem based on at least a die temperature of the system-on-chip;
the second controller is configured to determine a second proposed operation point for the subsystem based on at least the enclosure temperature of the enclosure; and
the selector logic is configured to select the one operation point from the first and second proposed operation points to send to the subsystem for enforcement, the one operation point selected to ensure that thermal and power requirements are met for both the first controller and the second controller.

16. The system-on-chip of claim 15, wherein the one operation point is a minimum of the first and second proposed operation points.

17. The system-on-chip of claim 14, wherein:
the prediction includes at least a future die temperature of the subsystem, a future power profile of the subsystem, and a future enclosure temperature of the enclosure; and
the prediction is generated based on the current temperature of the subsystem, a current power profile of the subsystem, a performance residency associated with the current operation point of the subsystem, and the enclosure temperature of the enclosure.

18. The system-on-chip of claim 14, wherein the at least one thermal-control system further comprises:
a metrics module configured to calculate, based on the prediction, metrics associated with the at least one subsystem; and
a weight module configured to determine weighted-metric thresholds for the subsystem based on the prediction.

19. The system-on-chip of claim 18, wherein the policy adjustor is further configured to:
determine tradeoffs between the metrics, the weighted-metric thresholds, and the user perception of the upper limit to the enclosure temperature; and
determine the thermal-control policy based on the tradeoffs.

20. The system-on-chip of claim 18, wherein:
the metrics include at least one of an average power, a filtered power, a filtered enclosure temperature, an average enclosure temperature, a filtered IP temperature, or an average IP temperature; and
the weighted-metric thresholds include one or more of an IP-temperature limit, an enclosure-temperature limit, a power limit, an IP-temperature-residency limit, and an enclosure-temperature-residency limit.
